(19) United States
(12) Patent Application Publication
(10) Pub. No.: US 2011/0106626 A1
(43) Pub. Date: May 5, 2011

(54) Method and System for Real-Time Insertion of Advertisements into Mobile Messages

(75) Inventors: Joerg Christof Zender, Renton, WA (US); John Henry Kuhlman, Redmond, WA (US); Larry A. Setlow, Redmond, WA (US)

(73) Assignee: Wireless Services Corp., Seattle, WA (US)

(21) Appl. No.: 12/911,740

(22) Filed: Oct. 26, 2010

Related U.S. Application Data
(60) Provisional application No. 61/255,010, filed on Oct. 26, 2009.
(60) Provisional application No. 61/255,026, filed on Oct. 26, 2009.

(51) Int. Cl. G06Q 30/00

(52) U.S. Cl. 705/14.64; 705/14.4

(57) ABSTRACT

The present invention is directed to Short Message Service (SMS) and Multimedia Message Service (MMS) based advertising, and more specifically to methods and systems for the real-time insertion of one or more ads into said messages for effective and targeted advertising to consumers. In one embodiment, a web-based purchasing marketplace (i.e. an Ad Marketplace) is provided, which facilitates sale, by publishers to advertisers, of ads space on a publisher's message or message inventory. In a further embodiment, methods and systems for managing the process by which ads are selected and inserted into a given message, in real-time, without substantial interruption of the standard process for delivery of said message during a messaging campaign, are provided.

### CROSS-REFERENCE TO RELATED APPLICATIONS

This application claims benefit of U.S. provisional applications 61/255,010 and 61/255,026 filed Oct. 26, 2009, the entire contents of which are hereby incorporated by reference. This application is also related to commonly assigned application, entitled “Real-Time Mobile Advertising Marketplace,” filed concurrently herewith, the contents of which are hereby incorporated by reference and pending U.S. application Ser. No. 11/854,461, filed Sep. 12, 2007, the entire contents of which are hereby incorporated by reference.

### FIELD OF ART

The present invention is directed to methods and systems for the real-time insertion of ads into one or more SMS or MMS messages during a mobile messaging campaign and a web-based Ad Marketplace for the purchase of ad space on said messages.

### BACKGROUND OF THE INVENTION

The mobile phone, and other mobile devices, is in common use today. Today's mobile devices provide not only a mechanism to place telephone calls but are often used to send and receive Short Message Service (SMS or text) and Multimedia Message Service (MMS) mobile messages, collectively referred to herein as “message” or “messages.” These messages can be phone-to-phone or peer-to-peer (i.e. one handset to another or one person to another) personal communications, or can be application-to-peer, or A-to-P, originated from a source other than another phone. These externally A-to-P generated messages can include news, weather, sports, chat, financial alerts or links to other content, video games, ringtones, or multimedia content including video, tv and other media content; and can be in direct response to an end user's entries or queries, or the result of an end user signing up for any of the aforementioned A-to-P services. With the advent of messages on the mobile device, and the large number of mobile devices in use around the world, comes a tremendous marketing opportunity for advertisers. However, determining which advertisements to place with which message, and how to insert that advertising, remains complex. Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified. For a better understanding, reference will be made to the following Detailed Description, which is to be read in association with the accompanying drawings, wherein:

FIG. 1 is a system diagram of one embodiment of an environment in which the embodiments of the invention may be practices;

FIG. 2 is illustrates one embodiment of a general top-level flow of message traffic;

FIG. 3 illustrates one embodiment of an ad serving system of the present invention;

FIG. 4A illustrate one embodiment of a general message and ad insertion flow;

FIG. 4B illustrates yet another embodiment of a general message and ad insertion flow wherein a response to an ad request results in a redirect response;

FIG. 5 illustrates one embodiment of a complex message and ad insertion flow showing multiple redirect responses and multiple ads returned in response to an ad request.

### DETAILED DESCRIPTION

The present invention is described more fully with reference to the accompanying drawings, which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Similarly, the phrase “in another embodiment” as used herein does not necessarily refer to a different embodiment, though it may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

### Overview

Briefly stated, the present invention is directed towards systems, methods, and devices for SMS and MMS based advertising, and more specifically to the real-time insertion of one or more ads into a message.

In a first aspect of the invention, an Ad Marketplace is provided. In a preferred embodiment, Ad Marketplace is a web-based exchange for the sale and purchase of mobile ad space on one or more of a publisher's messages or inventory of messages. As used herein, “publishers” are entities that generate the A-to-P messages into which one or more ads will be inserted. Further “advertisers” are the entities that have an inventory of ads they wish to place on, or into, one or more of a publisher's messages. Exemplary embodiments and features of the web-based Ad Marketplace are provided in greater detail in co-pending, commonly assigned patent application entitled, “Real-Time Mobile Advertising Marketplace,” filed concurrently herewith and for which the entire contents are hereby incorporated by reference.

In the second aspect of the invention, methods, devices and systems that enable the real-time insertion of ads into one or more of a publisher's messages during a mobile messaging campaign are provided. In a preferred embodiment, there is little or no latency in the delivery of an ad-inserted message to an end users device. As used herein, latency is refers to how long the process of inserting an ad takes and how long it delays the message delivery process. Messaging delays of more than one-half second, when added to the other latencies in the sending and carrier systems are considered be noticeable by the end user. Performance exceeding that is considered to be in real-time, as there is no apparent delay. The system described herein exhibits typical per message latency of approximately 0.5 seconds and thus allows for real-time ad insertion.

By way of example, SMS and MMS campaigns are often associated with popular TV show such as American Idol or Deal or No Deal, on major networks, like CBS, NBC Universal, to name a few. During these shows, the television viewing audience is encouraged to participate in a mobile messaging campaign by sending a message from their mobile devices. As will be recognized by those skilled in the art, these are high capacity mobile messaging campaigns, wherein a large volume of messages is being exchanged in a relatively short time period. In this example, as well as for other classes of application-generated mobile messaging campaigns, message delivery is time critical, and messages need to be sent as quickly as feasible. Typically, these messages are sent as fast as the cellular carriers allow, often in the cumulative throughput ranges of 2,000 to 5,000 messages per second. In addition, there are times when there are time critical responses to incoming messages originating from the end-users, such as votes during popular interactive TV campaigns, and quotes/queries. These incoming messages can also be in the 2,000 to 5,000 messages per second range, and the responses should be delivered in a timely fashion as achieved with the present system. Via the Ad Marketplace of the present invention, publishers (in this case the television network or show producers) can provide potential advertisers with a scheduled inventory of popular interactive TV shows having associated SMS or MMS campaigns (i.e. a message inventory) into which ads can be inserted in real-time, just prior to a message being sent to an end user. Further, advertisers can easily review and purchase message inventories and submit ads for insertion into a publisher's TV-originated mobile messaging campaign. The Ad Marketplace can further provide advertisers with aggregated and detailed viewer data, such as demographic, geographic, behavioral and other audience details, allowing for more targeted and effective consumer advertising.

As will be appreciated by those skilled in the art, any publisher content is eligible for ad insertion, including, but not limited to television content, or other forms of multimedia and text content provided as part of a mobile messaging campaign. Turning now to the drawings, the systems, platforms and applications, which enable the real-time ad insertion is provided. While the present invention are discussed in the context of high capacity mobile messaging campaigns, it should be noted that the present invention is not limited to this context and may be employed in any messaging campaign as well as to insert ads into P-to-P messages.

### System Overview

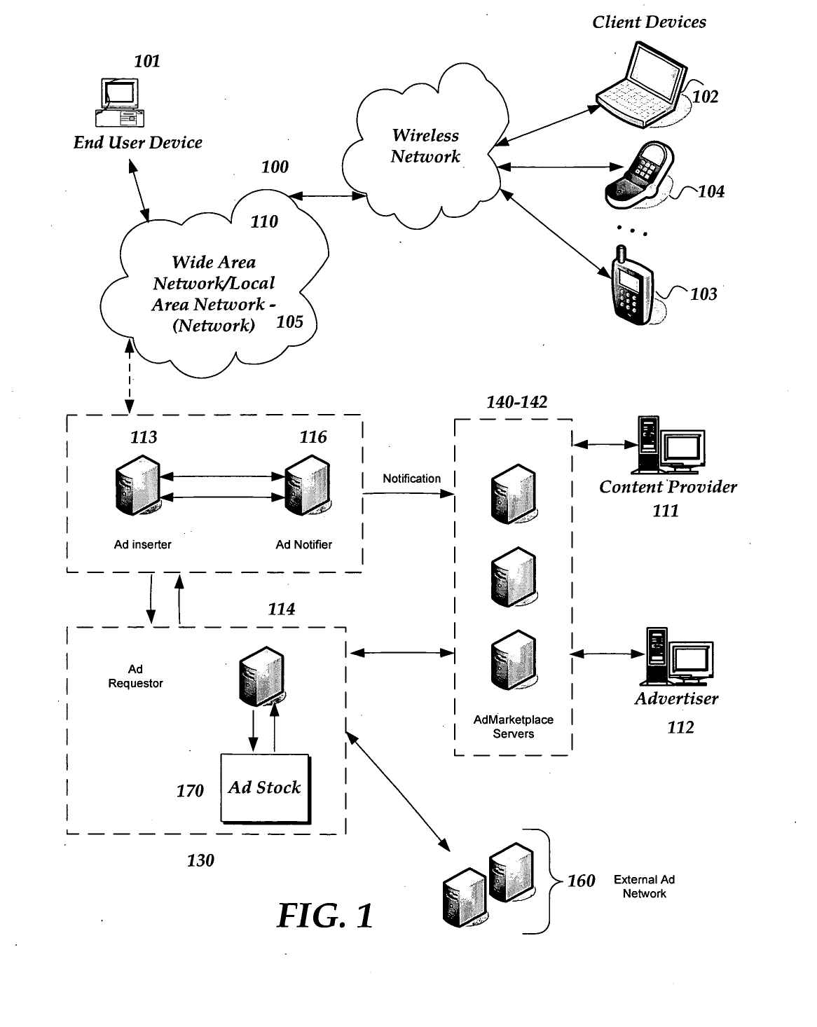

Turning now to the figures, FIG. 1 illustrates one embodiment of an environment in which the present invention may be practiced. As shown, system 100 of FIG. 1 generally comprises local area networks (“LANs”)/wide area networks (“WANs”)-(network) 105, wireless network 110, end user devices 101-104, publisher 111, advertiser 112, router 130, ad inserter 113, ad notifier 116, ad requester 114, and Ad Marketplace servers 140-141. In general, ad inserter 113, ad notifier 115, ad requestor 114 represents any device, platform, application, server or the like having the features and capabilities described herein. Also shown are external ad network 160 and internal ad stock 170, which is a local cache or source of ads within ad requestor 114. End user devices 102-104 may include virtually any mobile device capable of receiving and sending a message over a network, such as wireless network 110, or the like. Such devices include portable devices such as, cellular telephones, smart phones, display pagers, radio frequency (RF) devices, infrared (IR) devices, personal digital assistants (PDAs), handheld computers, laptop computers, wearable computers, tablet computers, integrated devices combining one or more of the preceding devices, or the like. Generally, end user devices 101-104 may also be configured to operate over a wired and/or a wireless network. End user devices 102-104 may subscribe to receive text alerts, such as television show announcements, or the like, from publisher 111. Wireless network 110 is configured to couple end user devices 102-104 with network 105.

Generally, the process of real-time ad insertion is initiated by a message from publisher 111 intercepted by router or message routing application 130, which is then analyzed to determine whether said message is “ad eligible,” and if it is, the message redirected or sent to ad inserter 113 prior to the message being sent to an user device 101-104. Router 130 is configured to monitor for various message content headers, tags, or the like, to determine whether the message is identified as “ad eligible.”

Ad inserter 113 is configured to interact with router 130 or other message routers, in general to provide the functionality of inserting an ad into a message prior to that message being directed towards end user devices 101-104. In a preferred embodiment, ad inserter 113 is operationally coupled to ad requestor 114 and uses information in one or more of its configuration files and from the ad eligible message itself and sends a request for an ad to ad requestor 114, so that ad requester 114 can initiate the process by which an appropriate ad is returned to ad inserter 113. In general, upon receipt of an ad request from ad inserter 113, ad requestor 114, based on its configuration, and the content of the ad request, will determine which ad source the request will be sent in order to retrieve an ad and return or serve said ad to ad inserter 113. In general, ads to be served from internal ad stock 170 so as to minimize latency and improve throughput of messages. As will be appreciated by those skilled in the art, ad retrieval is substantially faster when ads are pulled from ad stock 170 than when a network request for an ad is made. In the event an ad is not found and returned from ad stock 170, ad requestor 114 may be redirected to one or more sources to retrieve an ad as further described below. This process is iterative and can involve a number of re-direct scenarios as discussed in further detail below.

In general, Ad Marketplace servers 140-141 store information about message and ad inventories, store specific ads, (text or multimedia ads), associate specific ads with specific message inventories. Because it has this association, the Ad Marketplace servers 140-141 can serve the appropriately-matched ads in response to the query from ad requester 114. In one embodiment, Ad marketplace servers 140-141 may also be configured to instruct ad requester 114 to seek advertisements from another source, such as external ad network 160 (i.e. redirect ad requestor from one ad source to another ad source as need). External ad network 160 may represent a plurality of different sources for ad (including but not limited to ad networks such as DART, Jumptap, Ringleader and the like), in addition to Ad Marketplace servers 140-141. Core functions of Ad Marketplace severs 140-141 include, but are not limited to: approving message inventory IDs (as described in detail below), content loading to the Ad Marketplace; providing inventory information; processing ad requests initiated by router 130 and/or ad inserter 113; performing ad matching and returning ads; returning default ads if no ads are available; directing ad inserter 113 to third party (i.e. external) ad networks 160 as appropriate.

Ad notifier 116 is configured to provide information to publishers, advertisers, and/or one or more of ad servers 190 about the status of an ad delivery attempt. Such information may include, for example, whether an ad was inserted, whether the message with an inserted ad was delivered, whether the message with the ad failed to be delivered, as well as other information, including a time, reasons for a failure, and the like. In one embodiment, such information may be provided on a continual or a periodic basis. However, the invention is not constrained to providing the information continually or periodically, and in another embodiment, the information may be provided based on a request for the information, an instruction indicating that the information is to be sent to a publisher 111, advertiser 112 or system administrator, or based on any of a variety of other criteria.

As will be appreciated by those skilled in the art, modifications to system 100 described generally above may be made without departing from the scope and spirit of the invention. For example, router 130 may be functionally incorporated into ad inserter 113. In yet another embodiment, ad inserter 113 may be incorporated with ad notifier 116, without departing from the scope of the invention. Ad Marketplace servers 140-142, ad requestor 114, and even ad inserter 113, and/or ad notifier 116, may be configured to provide security that authenticates and allows only registered entities, such as publishers 111, advertisers 112, and/or administrators to perform actions using the system 100 of the present invention. Thus, it should be noted that FIG. 1 is not to be construed as narrowing the scope of the invention, and other configurations, arrangements, or the like, of various devices may also be employed.

System 100 of the present invention provides unique opportunities and features to advertisers 112 and publishers 111. Publishers 111 can attempt to monetize available real estate on their messaging inventory by allowing insertion of ads. Via the Ad Marketplace, publishers 111 can upload and provide potential advertisers 112 an onscreen inventory of scheduled mobile messaging campaigns. Further aggregated end user data may then be offered that allows advertisers 112 to target ads to end users by various criteria, including demographic, geographic, behavioral, and/or psychographic. Time and location-sensitive mobile messaging campaigns information may also be provided. Publishers 111 may further showcase their mobile message inventory in one location to maximize their use of inventory and enable competitive pricing for advertisers. Advertisers 112 are provided an interface to a web-based Ad Marketplace for viewing available inventory, pricing, and demographic reach. Once various selections are made and the advertising is uploaded with associated preferences, such information may be transmitted to a publisher in real-time for viewing and approval. Publishers may also interact with Ad Marketplace to define new inventory, review pending inventory buys by advertisers 112 and/or accept or reject advertising requests. Once approved, the ad may be queued for serving into scheduled campaigns for various mobile devices using, for example, a mechanism described further below. As ads are running, advertisers and/or publishers can both view real-time performance metrics, such as impressions serviced (the number to times an ad has been inserted into a message), response rates, and/or revenue earned. Moreover, a status notification can be provided to advertisers 112 and publishers 111 regarding whether or not an advertisement was served to a consumer. In yet another embodiment, online creation and test of mobile advertisement campaigns are enabled, thus providing a test bed for creative ideas.

A variety of advertising strategies/programs can be utilized and enabled on system 100 to achieve effective consumer targeting and outreach by advertisers 112. For example, direct response messaging campaigns are also supported that include, for example, coupons/ticketing. Couponing sends electronic coupons to mobile subscribers as a way to enhance promotional campaigns. These coupons may be redeemed in stores and/or online and provide the instant gratification “push to purchase” element of mobile advertising campaigns. Other embodiments also provide for sending links to additional content or information. Other embodiments also provide for video pre/post rolls of video ad impressions into mobile video with a variety of segmentation parameters available for advertisers and agencies. Further, embodiments integrate click-to-call (CTC) phone numbers in consumer text conversations, such as interactive campaigns, sweepstakes, pools, voting, and/or mobile Web sites. Phone numbers maybe highlighted in a similar manner as a hyperlink to a URL might be. This approach may also be applied to click-to-link or click-to-video integrations. Further, embodiments enable connecting a brand with customers, providing interfaces, web based tools and the like, to create, send, and/or track a text message marketing campaign. As will be appreciated by those skilled in the art, these and other advertising programs can be affected employing the system of the present invention. Further, advertisers, agencies, and publishers can be provided with real-time reports and visibility into the success of such advertising programs. Advertisers are provided with tools to manage costs and monitor click-through-rates and impressions. Publishers are provided with the tools to obtain insight required to manage earnings and monitor fill rates and CPM (cost per impression).

### Generalized Operation

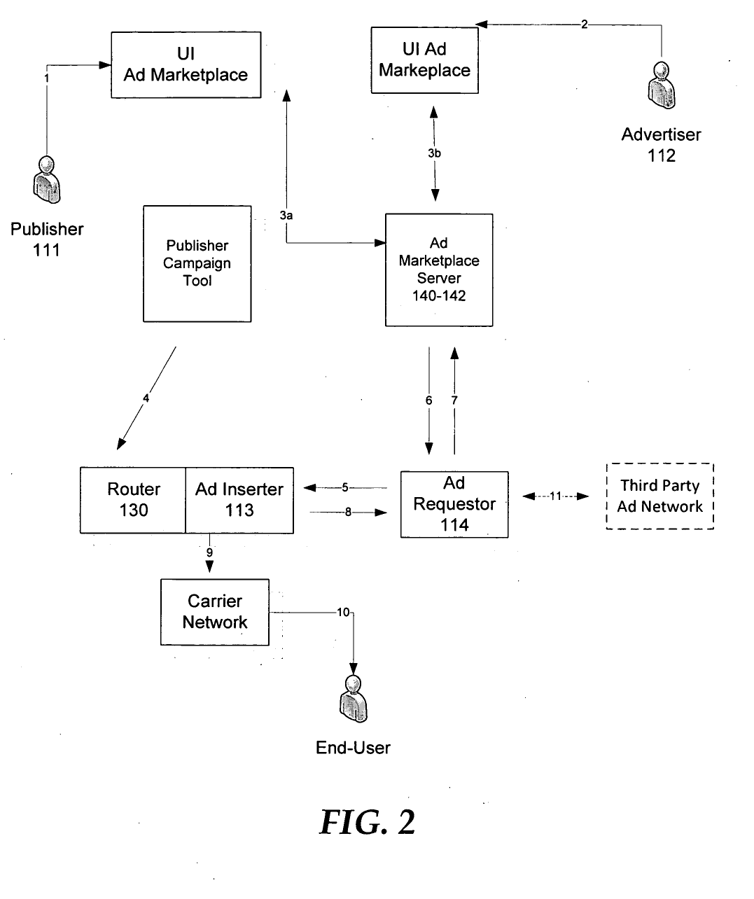

Next, FIG. 2 illustrates one embodiment of a general process for employing system 100. As shown, the following steps may be performed, though in certain cases not necessarily in the order provided below.

Step 1: Publisher 111 interacts with a web-based user interface (UI) of Ad Marketplace. Via the UI, publisher will define characteristics of an upcoming mobile messaging campaign. For example, for an upcoming mobile messaging campaign, publishers can use the UI to upload information regarding when and where the mobile messaging campaign will run, projected message volumes, and the like.
Step 2: Advertiser 112 via Ad Marketplace UI can discover and purchase message inventory associated with a publisher's messaging campaign, and define and upload ads to be inserted during a mobile messaging campaign.
Step 3a: An inventory ID is assigned to a publisher's mobile messaging campaign and loaded into Ad Marketplace server 140-141. In general, the inventory ID is a master identifier for a message that provides all information needed to create, track, purchase and match a particular message with an ad when that message is transmitted during a particular mobile messaging campaign.
Step 3b: Advertiser's ads loaded into the Ad Marketplace servers 140-141. In a preferred embodiment, the process of querying, matching, serving and inserting an ad into a message is an iterative process and described in further detail below.
Step 4: Publisher 111 initiates a message employing a messaging platform and/or a campaign tool. Message may be flagged for ad insertion (i.e. flagged as ad eligible) based on presence of an inventory ID and routed to ad inserter 113.
Step 5: Ad inserter 113 transmits an ad request to ad requestor 114 using inventory ID.
Step 6: Ad requester 114 will determine which ad source to send the request, for example internal ad stock 170 or initiate a network request from Ad Marketplace servers 140-142.
Step 7: If an ad request is forwarded to Ad Marketplace server 140-141, Ad Marketplace servers perform ad query, matching and serves ads for insertion. If no ad is available, a 3^{rd} party ad network's preloaded query string can be used.
Step 8: Ad requestor 114 returns an ad to ad inserter 113.
Step 9: Ad inserter 113 inserts ad into a message and the router routes the modified message to the appropriate destination or carrier network. Ad inserter 113 may perform one or more verifications of the modified message prior to routing the modified message for delivery to an end use. For example, ad inserter will verify length or size of the modified message. Based, in part on one or more checks or verifications, ad inserter 113 may opt to inhibit sending of the message Ad inserter may further log its actions, such that ad notifier 116 may provide ad status to the Ad Marketplace server 140-142 and thus the publisher 111, system administrator, and/or an advertiser 112.
Step 10: A modified message is delivered to the end user.
Optional steps (which may or may not be illustrated it FIG. 2) include the following:
Step 11: If Ad Marketplace server 140-141 returns a 3^{rd} party ad network query string to ad requestor 114, then ad requestor 114 queries the 3^{rd} party ad network and returns resultant ad.
Step 12: Ad notifier 116 sends a confirmation that the ad was served to Ad Marketplace servers 140-141.

### Ad Inserter, Ad Requestor, and Ad Notifier

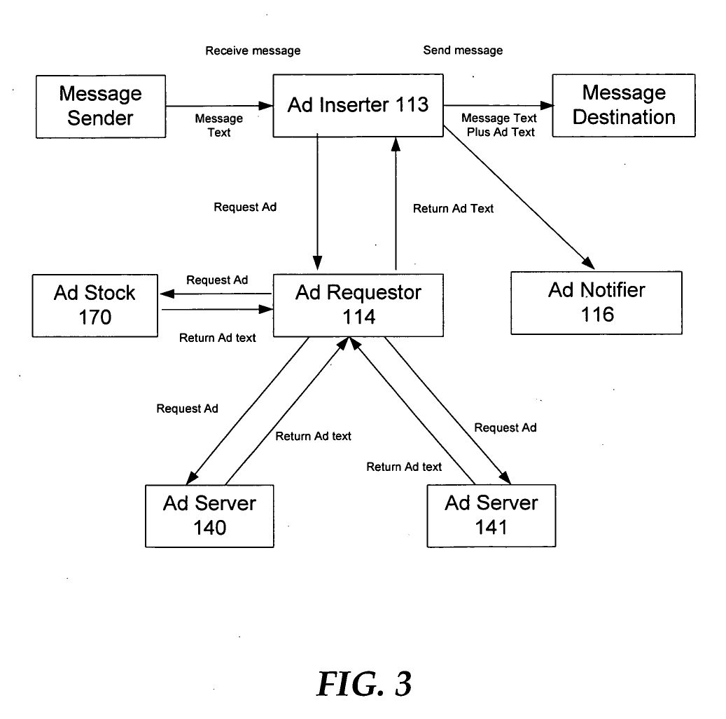

FIG. 3 is provided to illustrate in greater detail ad inserter 113, ad requestor 114 and ad notifier 116 and their interplay. FIG. 3 illustrates one embodiment for processing messages for real-time insertion of one or more ads during a mobile message campaign.

In a preferred embodiment, ad inserter 113 is configured to: 1) receive messages from a routing application, such as router 130; 2) request ads for insertion from ad requestor 114; and 3) insert the ad into the message and transmit/or send the message back to a routing device to be delivered to a destination, such as a mobile device, or the like. Ad inserter 113 may further perform various checks on the message, the advertisement, or the like, as described below, to determine, for example, a length and/or size of a message, length of a message and advertisement combination, or the like prior to routing the message to a router. Based, in part on the checks, ad inserter 113 may select to inhibit sending of the message with an advertisement, or insert the advertisement into the message. Ad inserter 113 may insert the advertisement in any of a variety of positions within the message, including appending the advertisement at the end of the message, inserting the advertisement at a beginning, or inside of the message. Ad inserter 113 may further log its actions, such that ad notifier 116 may provide transmit the status of the ad insertion processing to one of an Ad Marketplace server 140-141, a publisher, administrator, and/or an advertiser.

Ad requestor 114 is configured to receive an ad request from ad inserter 113, and depending on its configuration and on the ad request, and return an ad from ad stock 170, Ad Marketplace server 140-142, and/or external ad network 160 (collectively referred to herein as ad source). In one embodiment, ad requestor 114 will retrieve an ad from ad stock 170. As will be appreciated by those skilled in the art, because this ad stock reside in the memory of ad requestor 114 ad retrieval is substantially faster than making a network request to an external, network ad source. In general, retrieval ads from ad stock provides for low latency and improved throughput of messages.

In one embodiment, ad requestor 114 might receive a response from an ad source indicating that a requested ad might be obtainable from a different source, for example, an different ad source than ad requestor 114 first requested. As such ad requestor 114 might redirect its ad request to another Ad Marketplace server 140-142, for example. In yet another embodiment, a given message may be associated with an identifier specifying an ad source from which an ad is served by ad requestor 114. However, ad requestor 114 may also select an Ad Marketplace server 140-142 based on any of a variety of criteria. For example, in one embodiment, ad requester 114 might send a request to all ad servers, send the request using a round robin approach, send the request to a specific Ad Marketplace server 140-142, an ad server based on highest-values, or the like. Moreover, the ad requestor 114 may even rotate through different ads based on a number of requests. In a preferred embodiment, ad requestor 114 is configured formulate an ad request with sufficient information about the message to allow for the use of a single application programming interface or API regardless of the ultimate provider/source of the advertising content, and independent of the specifics of the interaction of the ad requestor 114 with the external ad source or advertiser.

As will be appreciated by those skilled in the art, ad inserter can be configured to maintain a persistent connection with ad requestor 114. In yet another embodiment, ad inserter 113 may be configured to maintain a windowed connection with ad requestor 114. In still another embodiment, ad insert may be configured to maintain multiple connections to ad requestor 114.

Ad notifier 116 is configured to receive, store and otherwise manage information from ad inserter 113, such as through a log or database table that might be stored in data stores, or the like, for use in providing a status of advertisement deliveries associated with the status of a message, a request of an ad, and other administrative information. Ad notifier 116, in one embodiment, might periodically provide status reports from information within the log or database table. Ad notifier 116 can be adapted to provide such information that includes, but is not limited to, whether a message was delivered successfully, or not; whether the message was delivered with an advertisement or not; and what type of advertisement. Ad notifier 114 may further indicate one or more reasons why a message was delivered without an advertisement, including for example, time outs, length issues, errors in advertisement matches, or any of a variety of other reasons. Such information provided regarding a given status is sufficiently complete to provide virtually a complete record of a message, a request for an ad, and the ad, including, for example, whether a carrier fails to accept the message. In one embodiment, notifications generated by ad notifier 116 may be transmitted to a publisher, advertiser, a system administrator (collectively referred to herein as ad managers) under certain circumstances, such as when an ad insertion attempt has failed for example.

As will be appreciated by those skilled in the art, while the process of ad-to-message matching and insertion has been described above and show in FIG. 3 as a simplified, linear process, it is, in fact, complex. The additional description below is provided to illustrate various scenarios involving different condition of how ads are requested and inserted into a given message.

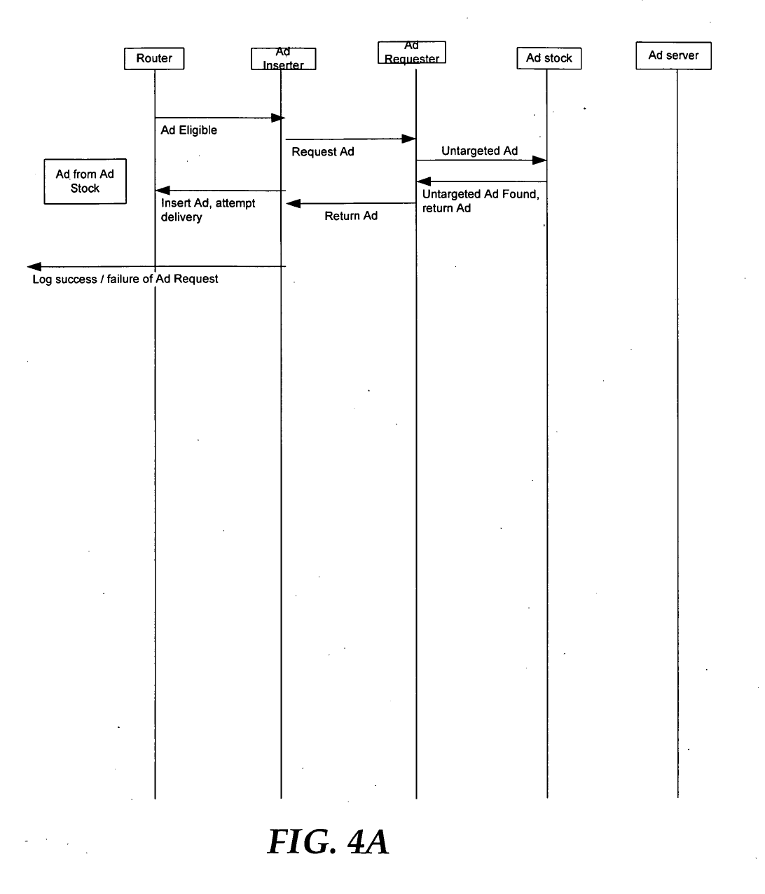

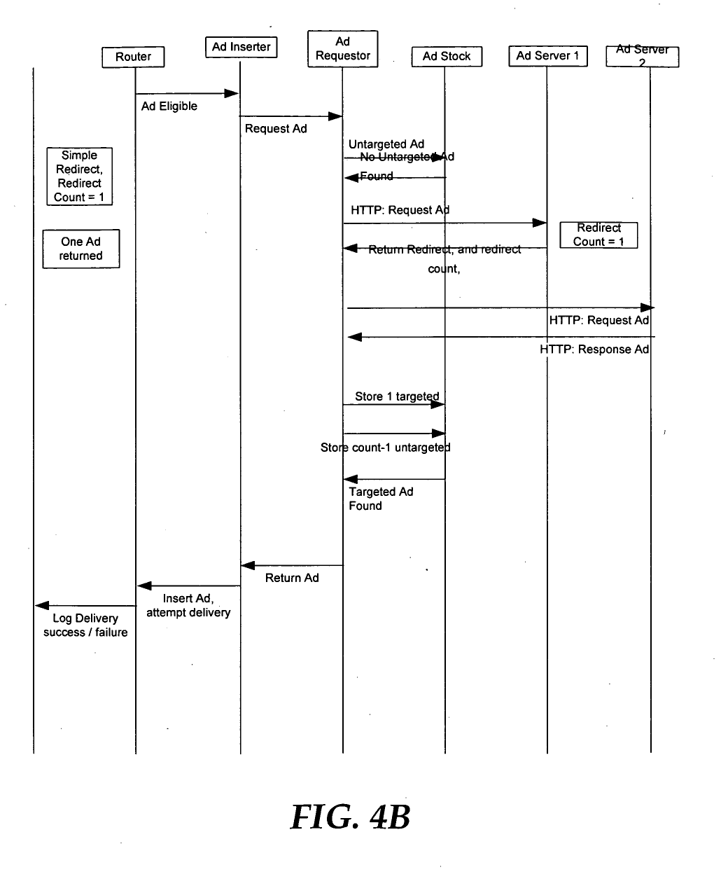

FIGS. 4A and 4B is provided to illustrate a simplified ad request and ad insertion process. In general a typical ad request flow is as follows: a message comes into the message routing application. The router determines that this message is ad-eligible, and sends it to the ad inserter. The ad inserter uses information from its configuration files, and from the message, and sends a request for an ad to the ad requestor. The ad requestor based on its configuration, and the on the contents of the request, decides which ad source (ad stock, Ad Marketplace server, external ad network) to which to send the request. It retrieves the ad from a transmitted response from an ad source, and returns the ad to the ad inserter. The ad inserter inserts the ad text into the message, resulting in ad inserted or modified message. This is passed on to a message router or routing application, and the modified message is sent out to the aggregator or carrier for delivery to the user's handset during a publishers messaging campaign.

In general, ads are requested and returned from the internal cache, or ad stock, instead of having to request an ad from an external ad source. This ad stock resides in the memory of the ad requestor, and retrieval is substantially faster than making a network request to an external ad source. Serving ads from ad stock has lower latency and improved throughput than making requests to external Ad Servers, and is very well suited to serving ads in high capacity mobile messaging campaigns. See generally FIG. 4A.

In yet another embodiment, a process referred to herein as “redirect” may be employed as part of an ad request process flow and is generally illustrated in FIG. 4B. In this scenario, an ad source and even a record in the ad stock can respond to an ad request with redirect information that instructs the ad requestor to go to another source to retrieve an ad for this request. When the redirect information is received, the ad requestor formulates another request to the redirected ad source, and sends it out requesting an ad. Processing then proceeds as in the general case provided in FIG. 4A. Also as illustrated in FIG. 4B, is yet another embodiment of the present invention, wherein an ad server may respond to with a MaxUse count value greater than one, meaning an ad can be used more than one time. One of these ads will be considered “targeted” and will be returned to the ad inserter to satisfy the initial ad request. The remaining count to ads and their ad text will be stored in the ad stock as “untargeted” ads and will be retrieved on subsequent ad requests until the MaxUse count value has been reached.

As discussed, the present invention is adapted to provide advertisers the ability to transmit targeted ads to specific end user devices or end users. In is enabled by employing the process of matching targeted ads with the appropriately corresponding ad-eligible messages. In the targeted ads case, when an ad request is made of ad requestor from the ad inserter, information about the original message is also sent, most particularly the end-user's destination phone number. This allows for end-user specific targeting. As used herein, a targeted ad is one for where there is a direct association of the ad to a specific end-user's phone number, these are specific to that phone number, and cannot be served to another phone number. Correspondingly, untargeted ads is one for which there is no direct association of the ad to a specific end user's telephone number and may be generic to a mobile messaging campaign. In some instances, not all publishers or advertiser require specific end user targeting and untargeted ads may be served and transmitted to an end user.

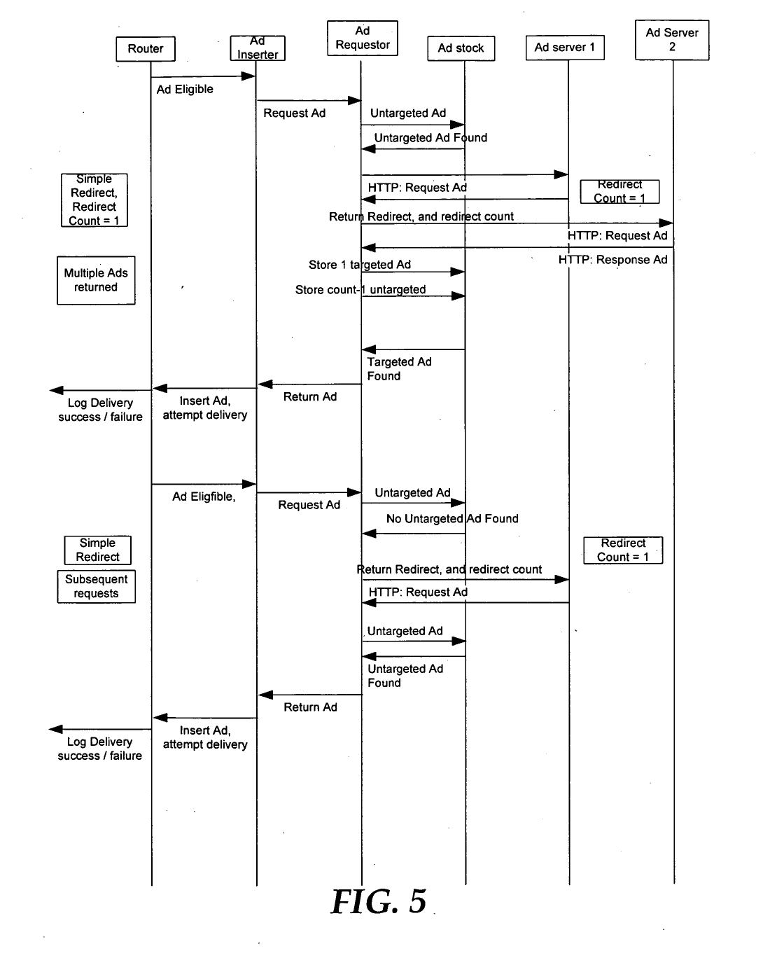

In yet another embodiment, multiple redirects (i.e. ad request to more than one ad source) and multiple ads are combined when an ad server returns a redirect with MaxUses>1. This message processing flow is illustrated in FIG. 5. In this instance, the ad inserter will redirect the next MaxUse requests to the secondary ad server without going back to the original ad server for each request. This manes that subsequent redirects will only query one Ad Server for each incoming request, rather than the two—one for initial ad request, and one for the redirect. These additional redirects are stored as untargeted redirects in the ad stock.

In yet another scenario, there may be circumstances wherein the ad server may run out of ads before a mobile messaging campaign is finished or completed. The ad stock can be configured to comprise one or more “fallback” ads or ads that are served when all other forms of ad requests have not yielded an ad.

In yet another embodiments, empty messages, i.e. ad-eligible messages without associated ads may be transmitted to an end user device. In this instance, an ad request from ad inserter is not fulfilled within a reasonable time, the insertion is aborted, and the message is sent out the router with no ad. This is specifically designed to avoid high latency when network, server, or application performance is too slow. It is more important to send the message than to insert the ad.

The above specification, examples, and data provide a complete description of the present invention. However, as will be appreciated by those skilled in the art, several modifications, additions or deletions can be made to present invention without departing from the scope of the invention. For example, an ad may be inserted in a variety of positions in a message, include pre-pending, post-pending or inserted within the message. In yet another example, ads may be inserted with character separators (such as a line feed, comma, or asterisk) usable to identify a location of an ad. Accordingly, since many embodiments of the invention can be made without departing from the spirit and scope of the invention, the invention resides in the claims hereinafter appended.

What is claimed as new and desired to be protected by Letters Patent of the United States is:

1. A high speed system for processing a mobile message and inserting an ad into said message, said system comprising:
an ad inserter configured to receive an ad eligible message and formulate an ad request; and
an ad requester, which is configured to receive the ad request from ad inserter and retrieve the ad from one or more ad sources and return the ad to the ad insertion for insertion into the ad-eligible message; and
wherein ad insertion occurs in real-time and prior to the ad-inserted mobile message being transmitted to an end user.

2. The system of claim 1, wherein real-time means a delay or latency per message of less than 0.5 seconds in the processing and insertion of the ad into the ad eligible message.

3. The system of claim 1, further comprising a notifier, which is configured to receive a status notification from the ad inserter and which can provide at least one of a publisher, advertiser or system administrator with said status notification.

4. The system of claim 3, wherein the status notification comprises information about a success or failure of an ad insertion attempt or an ad-inserted message delivery attempt.

5. The system of claim 1, wherein ad requestor comprises a local, in-memory ad storage of one or more ads from which one or more ads may be returned in response to the ad request.

6. The system of claim 5, wherein the ad requestor is further operationally coupled to one or more external ad servers from which one or more ads may be returned in response to the ad request.

7. The system of claim 6, wherein the ad requestor is redirected by a first external ad server to a second external ad server.

8. The system of claim 7, wherein the ad requestor is redirected by the second external ad server to a third external ad server.

9. The system of claim 6, wherein the ad requestor is redirected by the local ad storage to the one or more external ad servers in order to retrieve the ad.

10. The system of claim 6, wherein an ad returned from the one or more external ad servers may be returned to the ad inserter and also stored in the local, in-memory ad storage to be returned in response to a subsequent ad request.

11. The system of claim 9, wherein the redirect is comprised of an instruction to the ad reqeustor to query a specific external ad server in order to retrieve the ad.

12. The system of claim 10, wherein the ad retrieved from the external ad sever is transmitted to the ad inserter and is also stored in the in-memory ad storage to be served to satisfy additional ad requests.

13. The system of claim 11, wherein the ad retrieved from the one or more external ad servers may be inserted into more than one message.

14. The system of claim 11, wherein the local in-memory ad storage is configured to return ads in response to the additional ad requests.

15. The system of claim 1, wherein the ad retrieved is targeted to a specific phone number unique to the end user enabling end user targeted advertising.

16. The system of claim 1, wherein the ad returned is not targeted to a specific phone number and used for untargeted advertising.

17. The system of claim 1, wherein an attempt at ad insertion is aborted and the ad-eligible message transmitted to the end user without inserting an ad to limit the latency of the message delivery to within real-time.

18. A method for processing a mobile message and inserting an ad into said message at real time, in line with delivery of the message during a mobile messaging campaign, said method comprising:
intercepting and identifying the message as being ad eligible during the messaging campaign;
formulating an ad request with sufficient information about the message to enable an ad serving system to select an ad specific to the campaign and to the message.
transmitting the ad request and querying one or more ad sources, and
inserting the ad into the ad-eligible message and transmitting the ad inserted message during the messaging campaign.

19. The method of claim 17, wherein the ad-eligible message is transmitted to the end user without an inserted ad in order to preserve the real-time delivery of the message.

20. The method of claim 17, wherein the ad serving system comprises at least an ad requestor, which includes a local in memory storage of ads, and an ad inserter.
